(19) United States
(12) Patent Application Publication
(10) Pub. No.: US 2004/0153714 A1
(43) Pub. Date: Aug. 5, 2004

(54) Method and apparatus for providing error tolerance in a network environment

(76) Inventor: Rikard M. Kjellberg, Santa Cruz, CA (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/658,871

(22) Filed: Sep. 9, 2003

Related U.S. Application Data
(63) Continuation-in-part of application No. 10/622,319, filed on Jul. 18, 2003.
Application No. 10/622,319 is a continuation of application No. PCT/SE02/00092, filed on Jan. 18, 2002.

(30) Foreign Application Priority Data
Jan. 19, 2001 (SE) 0100148-6
Feb. 19, 2001 (SE) 0100530-5

(51) Int. Cl. H04L 1/22

(52) U.S. Cl. 714/4

(57) ABSTRACT

A method for establishing error tolerance in a processing system is described. Multiple autonomous processes dynamically assign themselves unique, platform-independent identities upon their creation. Automated creation of backup processes occurs, which automatically replace existing primary processes that have disappeared. Each process maintains surveillance of other processes. If one process is lost, the other processes are independently so advised, allowing them to automatically negotiate which process should replace the lost process. Once the replacement process has been determined, it will automatically replace the lost process. In addition, the consistent flow of backup processes based on each type of service is provided. If a predetermined period of time lapses without a response from a primary process, one of the backup processes of the same service type will quickly replace the lost process. This backup process, which has now become a primary process, is replaced with a newly created backup process.

This is a continuation-in-part of U.S. patent application Ser. No. 10/622,319, filed on Jul. 18, 2003, which is a continuation of international patent application no. PCT/SE02/00092 filed on Jan. 18, 2002 under the Patent Cooperation Treaty (PCT), which claims priority to Swedish patent application no. 0100148-6 filed on Jan. 19, 2001 and Swedish patent application no. 0100530-5 filed on Feb. 19, 2001.

### FIELD OF THE INVENTION

The present invention relates to the field of computer networks and fault tolerance systems. In particular the present invention discloses a method and system for automatically creating standby processes within a computer network in order to provide backup support in the case where a primary process is lost or removed from the system.

### BACKGROUND OF THE INVENTION

It is well known within the present technical field that distributed server architectures commonly include hardware modules that are interconnected, often over a Local Area Network (LAN). Distributed server architectures and software processes have been used for a long time. Multiple software processes can co-exist in the same hardware module, and the roles of the various software processes may vary. One software process may act as master supervisor and watch over all other software processes. The traditional way for a master to supervise existing processes and resources, in distributed server architectures, requires each process or resource to periodically send a message to the master to announce its existence and status. These periodic messages are sometimes referred to as “keep-alives”.

A commonly used system for providing the above system is Sun Microsystems' server architecture known as “Jini”. Jini is a self-configuring, distributed server architecture, which has properties that support plug-n-play functionality. Jini networks contain a Jini server, which forms the implementation of a look-up service, which also operates as a master. Jini networks may comprise a plurality of Jini servers in order to structure the resources of the network participants or to implement error tolerance in the master function. In addition to the Jini server, Jini networks usually comprise other participants such as: storage units, printers, PC's, other servers, etc.

As soon as a new participant (i.e. a hardware component or process) connects to the network, it sends a broadcast message in order to announce its presence to the Jini server. The Jini server replies with an interface, which allows the participant to register its service with the look-up service of the Jini server. Accordingly, the new service is added to a resource table within the look-up service, which other clients can then access. A client, such as a PC, may request a service (e.g. printer) by accessing the resource table of the look-up service. Hence, the PC becomes a client and the printer acts as a resource server by supplying a printer resource.

Note that participants contained in the look-up service table are required to periodically send keep-alive messages to the Jini server in order to notify of their continuous presence within the system. If a pre-determined message interval is not met by a given resource, its process is removed from the look-up resource table.

Conventional systems, as known from the prior art, have a number of well-known problems. These problems are based on the basic system architecture mentioned above and are difficult to remedy. Thus, the prior art involves problems such as: bottlenecks, single-points-of-failure, lack of error correction, static capacity, static configuration, static types of services and static architecture.

Bottlenecks are the single greatest problem that occurs in typical distributed server architectures when all communications must interact with the master. This implies that a bottleneck can arise when too much network traffic is forced to interact with a single resource.

Single-point-of-failure occurs when the master disappears from the network. The entire system stops working because all extraneous resources are dependent on the master. This indicates that failure at a single place can lead to failure of the entire network.

Lack of error correction occurs in conventional server systems since they have no intrinsic capacity to remedy errors automatically. If a server crashes, the overall system remains with one less resource, and thus the robustness of the system is lowered. Re-establishing the previous level of robustness usually requires manual intervention by network administrators. Hence, critical systems require continuous supervision and maintenance, which can be costly.

Static capacity can become a problem during increased workload. The system is pre-configured to provide a set of resources and is unable to add or remove resource capacity with changes in demand for the resources. Handling an increase in capacity requires manual intervention to physically add more resources to combat the increased load. Again, such manual intervention and continuous supervision can be costly.

Static configuration exists in the prior art such that installing new resources requires manual configuration. Such configuration often leads to disruption of a system in operation. This process is often complicated, work intensive and can have consequences on the quality of service in an operational system.

Static service types are another common problem with distributed systems. The problems lie in the identification of these different types of services or jobs. For example, a printer must be identified as a server when it executes printing requests. A conventional way to handle service identification is to set up an organization or institution, which is responsible for allocating the identities to different service types. If an operator develops a new type of service, he must apply for a new, unique service-ID for the organization. Before this new service or job becomes compatible with its environment (i.e. able to work together with products from other operators), its identity and interface must be hard coded into the system. This complicated process results in incompatibilities between different products, even though open environments are desirable (at least by the users).

Under a static architecture, redundancy and scalability of a network must be administered manually. Furthermore, processes are partially identified by their physical address such that they cannot take their identities and migrate to other hardware modules. Child processes (threads) cannot be independently broken away from their parent-level processes, because the parent solely owns and controls them. Only the parent-level process itself can deploy its respective child sub-processes.

One of the major problems with the prior art is attributed to the lack of independent error tolerance. The purpose of independent error tolerance is to protect the entire system from problems if an individual component disappears in an uncontrolled way. Such tolerance is implemented by means of redundancy as a form of overcapacity. A system with built-in error tolerance contains active processes, which manage the nominal operation of a network. Active processes are given a status of primary. In addition to these primary processes, built-in redundancy exists in the form of passive processes, which do not participate in the nominal operations; they are considered dormant. Their function is to operate as reserve processes with a standby, or dormant status.

If any primary processes shut down, an equivalent standby process (of the same type of service) replaces the failing primary process. The standby process changes its status to primary and takes over the nominal operations of the failed process. Under such architecture, error tolerance is achieved and the system as a whole is not put out of operation due to the failure of a single component.

The concept of error tolerance is dynamic. However, this concept is restricted, because current server systems are based on static architecture. Hence the possibility of built-in dynamic functionality in a static environment has considerable limitations. An implementation of the primary/standby function in a static environment implies the following problems: single-point-of-failure, static configuration, and no error correction.

In a single-point-of-failure system, a master supervises and controls the primary/standby function in the system. This implies that the master must discover a failing process and activate an equivalent stand-by process. This means that the primary/standby function is dependent on the master. If the master or the connection between the master and the standby function were to disappear, the error tolerance would fail as well. Manual supervision and intervention would still be required.

“Hot-standby” is an implementation in which a primary process can be directly supervised by a corresponding standby process—a solution in which the master is completely avoided. But the problem with error tolerance still remains if the “hot-standby” process disappears. One solution might require several “hot-standby” processes, which supervise the same primary process. However, such an implementation still requires manual intervention when the numbers of “hot-standby” processes diminish over time.

Static configuration requires that configuration of primary and standby processes be done manually, before system start-up. Explicit declaration is required to state which process shall be primary and standby, as well as in which order the standby processes shall replace the primary processes upon failure. Static configuration is also required for “hot-standby” processes mentioned above. Such configuration is complex and requires manual supervision and intervention.

Lack of error correction can also be a problem when a primary process is lost and a standby process takes over, because the system now remains with one less resource. If the current domain only involved a single primary and standby process, there would be no standby process remaining and all error tolerance is void. This still requires manual supervision and intervention in order to restore the error tolerance.

The Jini architecture, described earlier, can be seen as a step in the right direction to solving some of the above identified problems of the prior art. Jini has been able to solve some of the above-mentioned problems such as static configuration and static service types. Self-configuration and dynamic download service interfaces are excellent features but only handle two of the above problems.

As to error tolerance in distributed server environments, there are no known solutions that are adapted to distributed and autonomous network environments. In order to achieve error tolerance in such environments, processes must be able to handle error tolerance independently and without manual intervention.

### SUMMARY OF THE INVENTION

The invention includes a method and corresponding apparatus, in which multiple processes of a particular service type are maintained in a processing system. A status is assigned to each process, from among multiple prioritized statuses, including an active status and a non-active status. Each of the processes is caused to monitor the other processes of said service type; and to respond autonomously to a predetermined condition by changing its own status between active and non-active.

### BRIEF DESCRIPTION OF THE DRAWINGS

A better understanding of the present invention can be obtained from the following detailed description in conjunction with the following drawings in which:

FIG. 1. illustrates the identification and registration of all participating processes and service types throughout a network whenever a newly created process enters the system;

FIG. 2. illustrates an exemplary method of admitting new processes into a network by reducing the probability of two processes simultaneously entering the system and sharing the same identification number;

FIG. 3. illustrates an exemplary method of assigning process identifications and service identifications to a new process entering a network; and

FIG. 4. illustrates an exemplary method of an autonomous process monitoring all other processes within a network in order to provide error tolerance against failed processes;

FIG. 5 shows a distributed architecture in which the present invention can be implemented; and

FIG. 6 is a high-level block diagram showing an example of a processing system in which the present invention can be implemented.

### DETAILED DESCRIPTION

The invention solves many of the problems that plagued the prior art such as: bottlenecks, single point of failures, lack of error correction, static capacity, static configuration, static service types and static architecture. The invention solves these problems by allowing processes to dynamically assign themselves unique, identities when they are created and introduced into a network. In short, the invention involves an autonomous process which: assigns itself a unique identity at startup; communicates directly with other processes in the system; updates itself continuously in response to other events in the system; maintains responsibility for its operations and status; and, automatically adapts itself to changes in the system.

The invention removes the concern of bottlenecks that occur in traditional network systems because no master server is required to maintain and police all the processes in an autonomous architecture as described by the present invention. No longer must all requests funnel through a single master server. In an autonomous architecture, each process maintains complete independence from other resource in a network.

In addition to the elimination of bottlenecks, the present invention also solves the problem of a single point of failure. Since the present invention does not require the use of a master server, the probability of a single point of failure vanishes. Each process works independent of everything else, hence no single point of failure exists.

The present invention also solves the problem of error correction and tolerance. The dynamic communication environment is assumed to be broadcast-enabled. An example of a broadcast-enabled communication environment is a multicast-enabled Internet Protocol (IP) network. Once the process becomes active, it begins broadcasting periodic heartbeat messages over the shared communication media (the network). This heartbeat message is transmitted at predetermined time intervals (e.g. every second). This heartbeat message may contain relevant information about the process including: identity, port, service type, server type, status, and workload. The remaining processes within the network share the same capability to broadcast their own heartbeat messages as well as receive such messages from each other. Hence, each process is capable of maintaining its own list of other available processes.

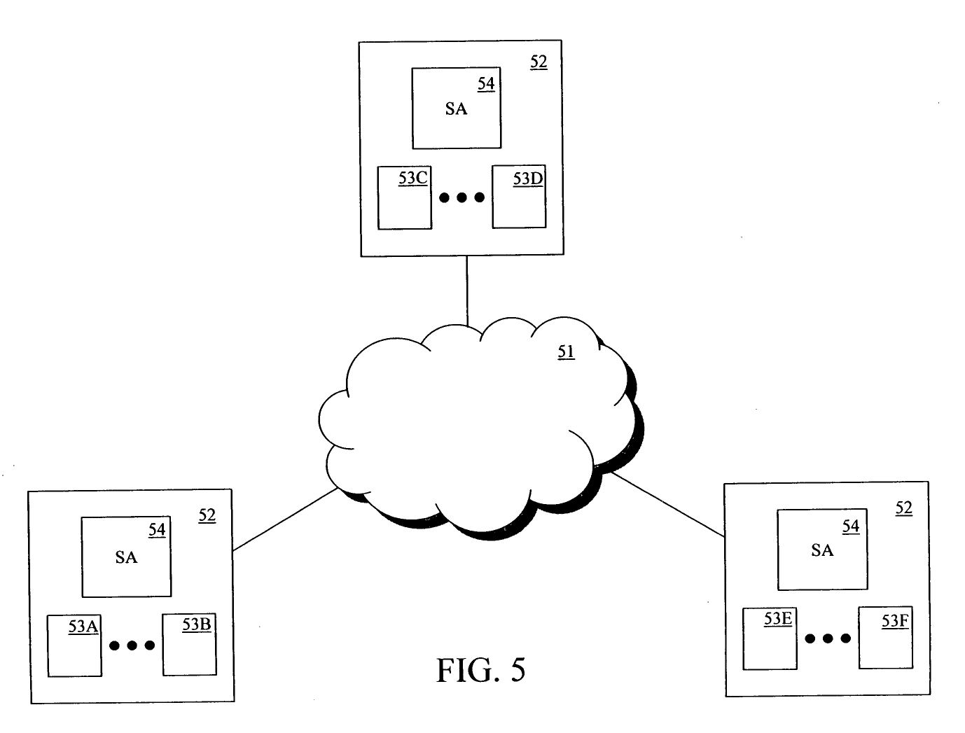

FIG. 5 shows a distributed architecture in which the present invention can be implemented. A number of hardware components 52 are connected to each other via a network 51, where the network 51 can represent multiple networks connected to each other. The hardware components 52 may be various types of computer systems and/or other processing systems, or subsystems thereof. Each of the hardware components 52 includes a Service Activator (SA) 54, the purpose of which is described below. Further, each of the hardware components 52 includes one or more processes 53 having the characteristics and functionality described below.

Through the use of heartbeat messages, the above architecture allows for automated error correction. The SA 54 listens for heartbeat messages from other hardware components. If a hardware component 52 stops sending a heartbeat message, the other components become aware of this change, and the SA 54 can automatically launch a new instance of the same service type as the process that ceased functioning. This results in dynamic error correction requiring no manual intervention. As old processes disappear or cease to function, new process are launched to take their place such that checks and balances are put in place to protect primary processes.

The problems of static capacity are also solved by the present invention. Dedicated processes, called load-balancing daemons, can monitor resource utilization and instruct an SA 54 to start or stop processes as feasible. Load balancing daemons can continuously direct tasks between different processes. Daemons, as well as all the other processes, maintain their own internal lists of resources. At any time, a daemon can redirect tasks to processes with low workloads. If a daemon discovers that an existing process is getting close to full load, it can instruct an SA to start up a new process and expand the system's available capacity. This functionality requires no manual intervention.

Static configuration is no longer a problem with the present invention. When new processes are introduced into a network, they immediately announce their presence through sending heartbeat messages. Through these heartbeat messages, all processes in the network can communicate with each other. This enables self-configuration by allowing each process to add, close, restart or even crash other processes without disturbing the nominal operation of the overall network environment. Processes can collaboratively decide which ones shall be primary and standby processes. No manual configuration is needed to make these processes known to each other or to set up a hierarchy of which processes act as standby and which ones act as primary.

The problems with static service types are solved by enabling the participating processes to dynamically and autonomously allocate themselves a suitable service type (based on a service ID). These processes also announce themselves to the system upon start up. Service IDs are associated with a service name of arbitrary format and length. However, the value is found in its ability to point to a URL, distributed object or program, which provides the interface for the current service. Thus each process provides the interface, which the overall environment needs in order to interact with a process. This method is dynamically accomplished on a component level.

Further, the present invention solves the problem of static architecture by enabling dynamic redundancy and scalability within and between hardware components throughout the system. Processes can migrate between hardware components because their identification number only identifies the process itself and not their physical address. Furthermore, a process can be divided into sub-processes, which can participate separately within the network environment. This enables sub-processes to be supervised and manipulated externally, without any need to go through related mother processes.

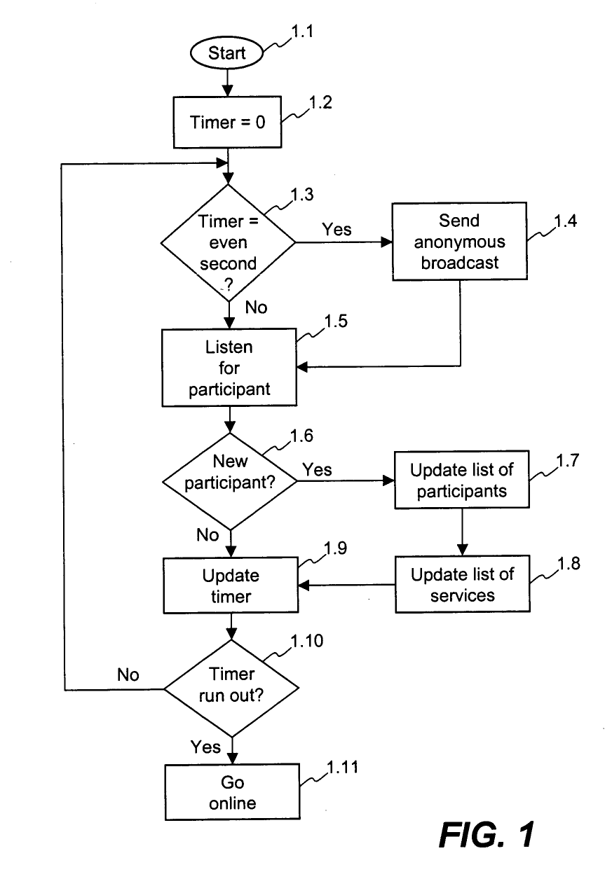

The present invention includes an algorithm, an example of which is shown in FIG. 1, to identify and register all participating processes and service types throughout the network whenever a newly created process enters the system. FIG. 1 begins at start step 1.1 where a new process is installed and booted into a network environment according to the plug-and-play method. At step 1.2, the booted process accomplishes its first event by setting a timer parameter (“Timer”) to zero. Next, at step 1.3, the process tests to establish if the value of Timer is even-numbered second (0, 2, 4, etc.). If the value of Timer corresponds to an even integer number, then at 1.4, the process sends an anonymous broadcast message into the network environment requesting all participants in the network environment to report back by means of a heartbeat message.

In one embodiment, all participating processes already send periodic heartbeat messages, (e.g. once a second), but some processes send heartbeat messages more or less frequently than others. Even though each process already sends heartbeat messages, they are instructed to immediately announce their identity once requested. To ensure that all participating processes receive the anonymous broadcast message, it is repeated every second for a pre-defined time period.

Thereafter the new process goes online and begins listening at 1.5 to all regular heartbeat messages from the existing processes in the network. These heartbeat messages contain information about process identification, service identification, status, workload, etc. As each heartbeat message is received, step 1.6 compares them to the existing list of processes to determine if a given heartbeat message was recently added or not. If a heartbeat message is new, step 1.7 will add it to the master list of process participants. Further, step 1.8 will add the new heartbeat message to the master list of services (which includes service identification numbers and names.) Next, step 1.9 updates Timer. In reference to 1.6, if a given heartbeat message is already contained in the master list of processes, steps 1.7 and 1.8 are bypassed and Timer is updated in step 1.9.

The subroutine contained in steps 1.3 through 1.9 are given a specific period of time in which to complete (e.g. three seconds). If this timeframe has not expired by the time the subroutine finishes, it will jump back to step 1.3 and begin again. For example, if the time accorded the subroutine is three seconds and the subroutine completes in 1.7 seconds, it will loop back to step 1.3 by incrementing Timer and continue to run through the remaining steps. When the subroutine returns to step 1.10, it will have exceeded the three-second timeframe (e.g. 1.7 seconds per pass=3.4 seconds). Once this occurs, the algorithm completes at step 1.11.

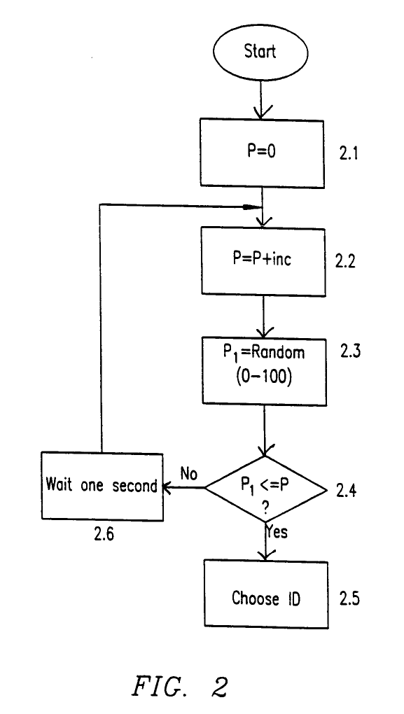

An example of the next algorithm of the claimed invention is illustrated in FIG. 2, which describes how the newly created processes from FIG. 1 are introduced into a network. FIG. 2 reduces the probability that two or more services, which concurrently enter a network, are accidentally assigned the same identification number. The process of FIG. 2 solves this problem by spreading the admission of new processes over time, thus making it highly improbable that two processes would select the same identification number.

At step 2.1, an admission probability parameter (“P”) is set to zero. Then step 2.2 increments P by a default value (“inc”). In one embodiment, P could be defined to increase by 10% every time this step is repeated. In step 2.3, a number (“P1”) between 0 and 100 is randomly selected. In step 2.4, if P1 is less than the previously incremented P, the process will immediately enter the system. However, if P1 is greater than P (e.g. P has been incremented to 20% and the value of P1 is randomly set to 37), the process moves to step 2.6. Once in step 2.6, the process waits one second, and then returns to step 2.2 where P is incremented again by 10%. The process repeats steps 2.3 through 2.6 until P1 is less than or equal to P. The algorithm illustrated in FIG. 2 increases the probability that the maximum wait time for a new process is ten seconds (assuming “inc” is set to 10%). Under such a method, process admissions are spread over time when several of them are concurrently created. It should be noted that the parameters chosen above are not limited as such. Any specific time interval or random number range could be chosen without deviating from the present invention.

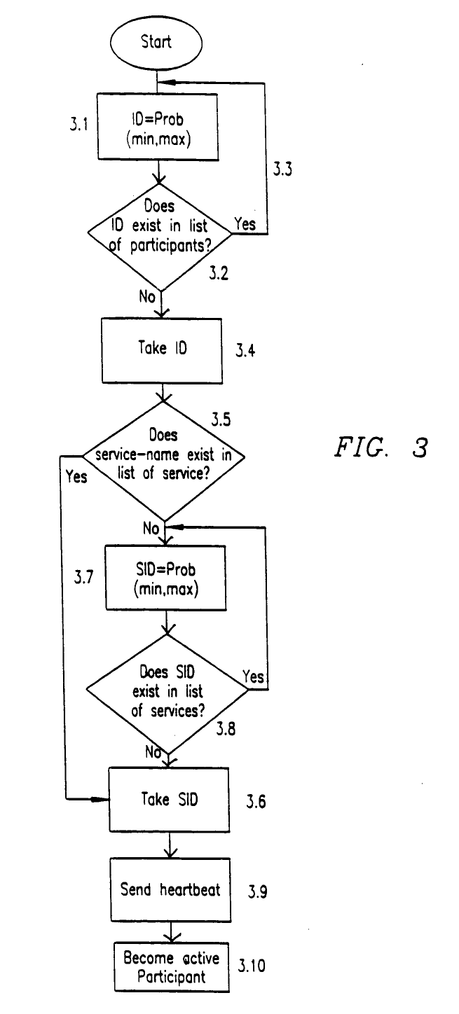

Once a new process is admitted to a network, a unique process identification (“PID”) and service identification (“SID”) are assigned in order for the process to become an active participant in the network. An example of this algorithm is illustrated in FIG. 3. In step 3.1, a number between 0 and 256 is randomly selected (the invention does not rely on this interval being between 0 and 256; any other interval could be used instead.). This number shall be tested as a possible PID. Thereafter in step 3.2, PID is compared with the identification numbers that already exist in the list of issued participants (FIG. 1). If PID is found in the list of issued participants, step 3.3 will loop the process back to step 3.1 to randomly select a new number. This procedure continues until the process finds an unoccupied PID. If the randomly selected PID is not occupied, step 3.4 allows the process to take this value, as its unique PID. Other minimum and maximum values could be used without altering the present invention.

In step 3.5, the service name of the process is compared with those already existing in the issued list of services (FIG. 1). If the service name already exists in the list of services (FIG. 1), step 3.6 allows the process to take this SID, which is already allocated to the current service name. If the service name does not exist in the list of services (FIG. 1), the process must allocate this service a unique SID (which is done in step 3.7). A number between 0 and 256 is randomly selected as a possible SID (this interval is only an example). Step 3.8 checks to see if the randomly selected SID already exists in the list of services (FIG. 1). If the SID has already been issued, the process returns to step 3.7 and repeats these steps until a new unique SID is found. Once a unique SID is found, the process moves to step 3.6 where it takes this SID.

It should be noted that a PID is unique for every process such that no two processes can share the same PID. However, SIDs are only unique for each type of service, therefore two services providing the same service type would share the same SID.

Under step 3.9, once the process has been assigned a unique PID and SID, the process announces its presence to the network by sending its own heartbeat messages. Lastly in step 3.10, the process becomes active in the network environment and its PID and SID become registered by the other participating processes.

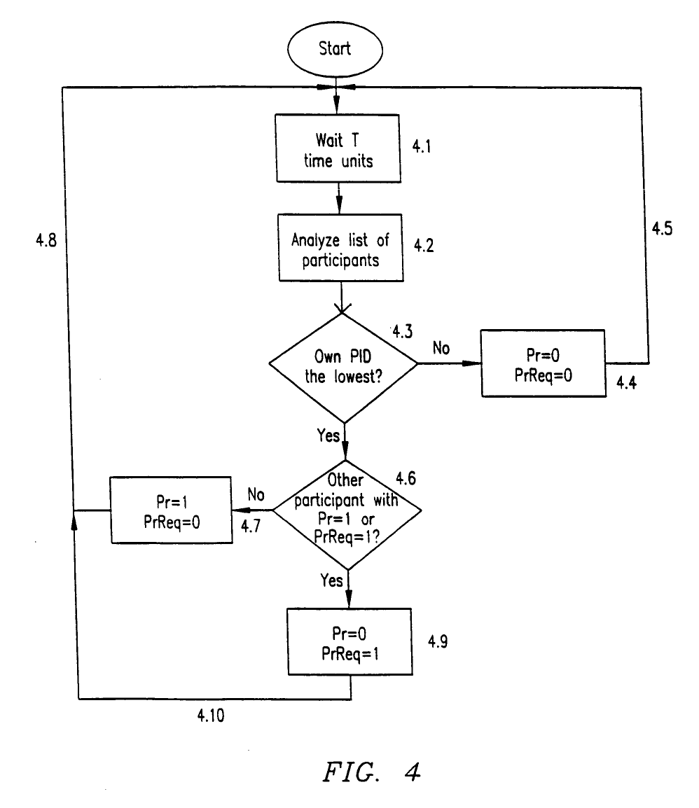

Once a process has been assigned a unique PID and SID and has been introduced into a network by sending heartbeat messages, the process becomes an active participant in the network environment. At this point, the process adopts the primary/standby algorithm taught above, and continuously executes the routine illustrated in FIG. 4. As processes disappear, new ones are created and replace them, such that no manual intervention is required.

In step 4.1, the process waits a certain number of time units (“T”). Once T runs out, the list of process participants is analyzed in step 4.2. Each autonomous process keeps its own internal list of process participants, which is continuously updated by incoming heartbeat messages from the other processes (FIG. 1). The complete list of process participants comprises information about all the processes in the network environment, such as: PID, SID, workload, status (primary or standby), etc. In regards to step 4.2, it should be noted that the analysis of the list of participants also includes the removal of “dead” processes. As an example, each process could have a time-out parameter that is some value longer than the heartbeat frequency. Every time a process fails to detect a heartbeat from another process, the time-out is decremented. When the time-out reaches zero, the process is removed from the list of participants.

In step 4.3, the current process checks if it has the lowest PID among the active processes which supply the same service (i.e. have the same SID) and participate in the primary/standby function. If the current process does not have the lowest PID, step 4.4 automatically places the process into standby status by setting the primary parameter to zero (Pr=0) as well as setting a primary-request flag to zero (PrReq=0). Next, step 4.5 loops the current process to the beginning of FIG. 4 and allows the process to follow the same steps until it has the lowest PID.

If the current process has the lowest PID, it moves to step 4.6 where a determination is made of whether another process is already assigned as primary (Pr=1) or is flagged to become primary (PrReq=1). If no other processes are primary (Pr=1) or are flagged to become primary (PrReq=1), step 4.7 sets the values of the current process to Pr=1 and PrReq=0. This gives the current process a status of primary. Next, step 4.8 loops the process back to the beginning of FIG. 4 to start over, where the process continues this loop until another process takes over as primary. However, if another process is already primary (Pr=1) or is flagged to become primary (PrReq=1), the requesting process goes into standby by setting Pr=0, but they are also flagged to become primary by setting PrReq=1. This means that an existing primary process switches to standby so that the current requesting process can go to primary status. Once this occurs, step 4.10 loops the primary process back to the beginning of FIG. 4.

It should be understood that the waiting time in step 4.1 is not directly dependent on any other timing parameter that exists in the network environment. It is appropriate to choose a time interval T which does not give an incoming process too much time in standby status.

It should also be noted that assigning processes a primary or standby status is only one embodiment. It is possible that a process is not assigned either status, and acts as solo process, such that manual intervention could allow for the assignment of this process to any service on a as needed basis. Also, a process should be free to ignore the algorithm in FIG. 4 and take over as a primary whenever it is required. It should also be noted that the algorithm for determining if a process is primary or standby may very well be based on a PID criterion other than the lowest PID.

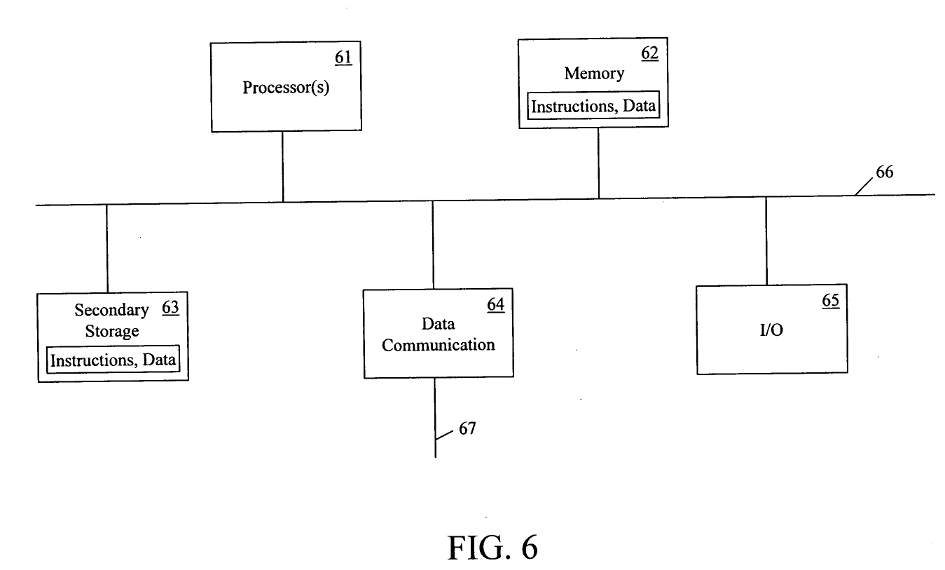

As will be apparent from the preceding discussion, the techniques introduced above can be implemented in software, which can be executed in computer systems and other processing systems with conventional hardware. FIG. 6 shows an example of a processing system in which the techniques described above can be implemented. Note that FIG. 9 is a conceptual representation which represents any of numerous possible specific physical arrangements of hardware components; however, the details of such arrangements are not germane to the present invention and are well within the knowledge of those skilled in the art.

The processing system shown in FIG. 6 includes one or more processors 61, i.e. a central processing unit (CPU), memory 62, secondary storage 63, a data communication device 94, and one or more additional input/output (I/O) devices 95, all coupled to each other by a bus system 66. The processor(s) 61 may be, or may include, one or more programmable general-purpose or special-purpose microprocessors or digital signal processors (DSPs), microcontrollers, application specific integrated circuits (ASICs), programmable logic devices (PLDs), or a combination of such devices. Memory 62 may be, for example, some form of random access memory (RAM). The bus system 66 includes one or more buses or other physical connections, which may be connected to each other through various bridges, controllers and/or adapters such as are well-known in the art. For example, the bus system 66 may include a “system bus”, which may be connected through one or more adapters to one or more expansion buses, such as a Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”). In alternative embodiments, some or all of the aforementioned components may be connected to each other directly, rather than through a bus system.

The secondary storage 63 may be, or may include, any one or more devices suitable for storing large volumes of data in a non-volatile manner, such as a magnetic disk or tape, magneto-optical (MO) storage device, or any of various types of Digital Versatile Disk (DVD) or Compact Disk (CD) based storage, or a combination of such devices. The communication device 64 is a device suitable for enabling the processing system to communicate data with a remote processing system over a communication link 67, and may be, for example, a conventional telephone modem, a wireless modem, an Integrated Services Digital Network (ISDN) adapter, a Digital Subscriber Line (DSL) modem, a cable modem, a radio transceiver, a satellite transceiver, an Ethernet adapter, or the like. The I/O devices 65 may include, for example, one or more devices such as: a pointing device such as a mouse, trackball, touchpad, or the like; a keyboard; audio speakers; and/or a display device such as a cathode ray tube (CRT), a liquid crystal display (LCD), or the like. However, such I/O devices may be omitted in a system that operates exclusively as a server and provides no direct user interface. Other variations upon the illustrated set of components can be implemented in a manner consistent with the invention.

Software (including instructions and data) to implement the techniques described above may be stored in memory 62 and/or secondary storage 63. In certain embodiments, some or all of the software may be initially provided to the processing system by downloading it from a remote system through the communication device 64.

What is claimed is:

1. A method comprising:
maintaining a plurality of processes of a particular service type in a processing system;
assigning a status to each of the processes, from among a plurality of prioritized statuses, the plurality of prioritized statuses including an active status and a non-active status;
causing each of the processes to monitor the other processes of said service type; and
causing each of the processes to respond autonomously to a predetermined condition by changing its own status between active and non-active.

2. A method as recited in claim 1, wherein the predetermined condition involves another process of the particular service type.

3. A method as recited in claim 2, further comprising causing each of the processes independently to maintain a list of other participant processes in the processing system.

4. A method as recited in claim 3, wherein the plurality of processes includes an active process and a non-active process corresponding to the active process, each independently maintaining said list.

5. A method as recited in claim 4, wherein the non-active process can autonomously change its status to active in response to an event affecting the active process.

6. A method as recited in claim 1, further comprising:
causing each of the processes to send heartbeat messages to each other process; and
causing each of the processes to listen for heartbeat messages from other processes;
causing each of the processes to update its list of participant processes based on receipt of heartbeat messages from other processes; and
causing each of the processes to update its list of participant processes based on the lack of receipt of heartbeat messages from other processes from which heartbeat messages have previously been received.

7. A method as recited in claim 1, further comprising assigning a unique process identifier to each of the processes, wherein each process determines its status based on its unique process identifier.

8. A method as recited in claim 7, wherein each process determines its status based on the value of its unique process identifier relative to the value of the unique identifier of each other process.

9. A method comprising:
introducing a plurality of processes into a processing system, each of the processes having a service type;
assigning a status to each of the processes, each said status selected from among a plurality of prioritized statuses, including a primary status and a standby status, such that at least one of the processes is a primary process and at least one of the processes is a standby process for the primary process; and
maintaining each of the processes so that each of the processes monitors its own status and the status of each other process of the same service type and can change its status from standby to primary without the user of a master, in response to an external event relating to a process of said same service type.

10. A method as recited in claim 9, further comprising causing each of the processes to maintain a list of other participant processes in the processing system.

11. A method as recited in claim 9, further comprising assigning a unique process identifier to each of the processes, wherein each process determines its status based on its unique process identifier.

12. A method as recited in claim 11, wherein each process determines its status based on the value of its unique process identifier relative to the value of the unique identifier of each other process of the same service type.

13. A method comprising:
introducing a plurality of processes into a processing system, each process having a service type;
causing each of the processes independently to maintain a list of other participant processes in the processing system.
assigning a unique process identifier to each of the processes;
causing each of the processes to send a heartbeat message repeatedly to each other process; and
causing each of the processes to listen for heartbeat messages from other processes;
causing each of the processes to update its list of participant processes based on receipt of heartbeat messages from other processes;
causing each of the processes to update its list of participant processes based on the lack of receipt of heartbeat messages from other processes from which heartbeat messages have previously been received; and
enabling each of the processes to select a status for itself, from among a plurality of prioritized statuses, including a primary and a standby status, without the use of a master, such that the plurality of processes includes a primary process and a standby process for the primary process.

14. A method as recited in claim 13, wherein for each process, the selection of status is based on the value of the unique process identifier of said process relative to the value of the unique process identifier of other processes having the same service type as said process.

15. A processing system comprising:
a plurality of processes, each process having a service type;
means for assigning a status to each of the processes, each said status selected from among a plurality of prioritized statuses, including an active status and a standby status, such that at least one of the processes is a primary process and at least one of the processes is a standby process for the primary process; and
means for maintaining each of the processes so that each of the processes monitors its own status and the status of each other process of the same service type and can autonomously change its status from standby to primary in response to an external event.

16. A processing system as recited in claim 15, further comprising means for causing each of the processes to maintain a list of other participant processes in the processing system.

17. A processing system as recited in claim 15, further comprising means for assigning a unique process identifier to each of the processes, wherein each process determines its status based on its unique process identifier.

18. A processing system as recited in claim 15, wherein each process determines its status based on the value of its unique process identifier relative to the value of the unique identifier of each other process of the same service type.

19. A method comprising:
maintaining a plurality of processes in a processing system, each process having an ability to independently monitor a status of each other process of said plurality of processes, without the use of a master; and
causing said plurality of processes to interact with each other to establish a priority of status, such that each of said plurality of processes can alter the priority of another of said plurality of processes without the use of a master to enable said interaction or alteration of priority.

20. A method as recited in claim 19, wherein said interaction and said alteration amongst said plurality of processes is used to enable fault tolerance for at least one of said processes in said processing system.

21. A method as recited in claim 19, wherein said status is one of: primary, to become primary, or standby.

22. A method as recited in claim 19, wherein said priority is based on a value of an identifier assigned to each of said plurality of processes.

23. A method as recited in claim 22, wherein said priority is further based on the status assigned to each of said plurality of processes.

24. A method for providing fault tolerance in a processing system, the method comprising:
enabling a plurality of processes in a processing system each to broadcast a periodic heart-beat message, wherein said heart-beat message includes an identifier for each of said plurality of processes;
enabling each of said plurality of processes to receive each said heart-beat message;
causing each of said plurality of processes to maintain an individual record of said plurality of processes;
causing each of said plurality of processes to update said individual record based on said heart-beat messages;
assigning each of said processes with a status, wherein said status is one of: primary, to become primary, or standby; and
enabling said plurality of processes to negotiate a hierarchy of control amongst each other based on the broadcast and receipt of heart-beat messages by each of said plurality of processes, wherein said hierarchy of control is based on the status of each of said plurality of processes.
